(19) United States
(12) Patent Application Publication
(10) Pub. No.: US 2022/0379370 A1
(43) Pub. Date: Dec. 1, 2022

(54) METHOD AND APPARATUS FOR PRODUCING CASTING SHELL

(71) Applicant: Hatton Designs of London Limited, London (GB)

(72) Inventors: Uriel Joseph, London (GB); Paul Withey, Birmingham (GB)

(21) Appl. No.: 17/737,608

(22) Filed: May 5, 2022

(30) Foreign Application Priority Data
May 25, 2021 (GB) 2107433.1
Apr. 5, 2022 (GB) 2204963.9

(51) Int. Cl. B22C 9/12; B22C 1/16; B22C 1/22; B22C 3/00

(52) U.S. Cl. CPC B22C 9/12; B22C 1/165; B22C 1/222; B22C 3/00

(57) ABSTRACT

A ceramic casting shell is formed by a method comprising the steps of coating a wax former with one or more layers of a ceramic slurry; drying the or each layer of ceramic slurry; wherein the dried layer or layers of ceramic slurry form a ceramic shell; applying over the ceramic shell, a coating of a polymer material; heating the formed assembly to melt and remove the wax former, wherein the polymer coating acts as a strengthening layer to the ceramic shell during the wax removal process; and subsequent to removal of the wax former, heating the ceramic shell to melt and remove the polymer coating. The polymer coating is preferably the outer coating of the ceramic shell. The polymer coating may be applied by spraying, dipping or painting onto the ceramic shell.

### TECHNICAL FIELD

The present invention relates to a method and apparatus for producing a casting shell, to an improved casting shell and to a method and apparatus for producing articles by means of the casting shell. The preferred embodiments are able to provide casting shells with improved strength and operational properties, particularly for use as investment casting molds.

### BACKGROUND ART

Investment casting is an important tool in the manufacture particularly of metal components, including precision components. It typically relies on the use of ceramic molds, or casting shells, that are formed around a wax former that replicates the shape of the component to be cast. The production of ceramic casting shells often suffers various shortcomings, drawbacks and disadvantages.

Ceramic investment casting shells or molds are conventionally made by a process that involves coating a wax former with repeated layers of a ceramic slurry, with intervening layers of ‘stucco’ (a sand-like particulate) which helps the next ceramic layer to stick to the previous layer of ceramic material. Each coating layer must be dried prior to the next being applied. Once it is determined that a sufficient number of layers of ceramic material have been applied, specifically once it is determined that the thickness of the ceramic shell is sufficient, the wax is removed, to leave a ceramic shell which, after further processing described below, can be used as a mold for the creation of cast articles. The process of removing the inner wax former is known as dewaxing and involves heating the assembly of ceramic mold and wax former to a temperature sufficient to melt the wax.

The dewaxing of wax-ceramic molds is critical to the investment casting process, and in practice represents the first major hurdle that needs to be overcome in creating good quality ceramic shells suitable for use in casting.

The shell mold, after the completion of shell build but before curing, is not particularly strong. The formation of the final ceramic structure requires the mold to be heated to over 800° C. for an hour or more. If the mold is heated slowly to these temperatures while the wax is still in place, the shell and wax will heat up in a uniform way, which will expose the ceramic to high internal stresses due to the expansion of the wax prior to its melting. The wax can have a co-efficient of thermal expansion of up to ten times that of the ceramic. Under these conditions the ceramic will just break or crack.

In seeking to alleviate this problem, the industry has developed a method of removing the wax from the shell mold, which relies on the poor thermal conductivity of the wax. Heat is applied rapidly to the shell mold. As a consequence of the high thermal conductivity of the ceramic shell mold, heat is transferred rapidly to the wax, which causes the outer surface of the wax former to melt before any significant heat reaches its bulk due to the poor thermal conductivity of the wax. The outer surface of the wax can melt and flow away, reducing the amount of wax in the interior of the cast. This allows the expansion of the wax to be accommodated through this surface melting and removal.

More specifically, this rapid dewaxing process comprises introducing the wax filled ceramic molds at room temperature into an autoclave. The autoclave door is closed and locked, and thereafter approximately 7-10 bars of superheated steam pressure is applied to the outside surface of the ceramic mold, immediately heating up the mold's outer surface to approximately 180° C. This superheat penetrates the mold and causes the surface of the internal wax to melt. During this process, the wax can increase in volume by 5-10% depending on its constituents.

The internal pressure caused by the expansion of the wax even at this reduced amount is significant and has the capability to damage the integrity of the enveloping ceramic shell. Failure of the ceramic shell is likely to occur if the mould has insufficient strength to compensate for the stresses applied. After this dewaxing process, the mold needs to be assessed for its structural capability. If it is found to have suffered non-structural damage, the mold can be patched with ceramic cement in the damaged areas and then sent further through the process. If the failure is found to be more significant, the mold could potentially be useless and need to be discarded.

It is common for molds to be patched and sent through the process. That is not to say that such molds are as good as non-damaged molds, as the patching only allows for the mold to make it through the casting process. Thereafter, the final cast product will potentially need remedial work to compensate for anomalies produced by the repaired ceramic mold.

All of this is undesirable and can result in significant losses to a foundry. The cost of manufacturing a sound casting is at least the same as the cost of casting a mold that either fails or needs remedial work. These fiscal losses represent a significant part of a foundry's profit. Furthermore, if the problem is significant and repeated, it can lead to delays in providing acceptable products to a customer, with consequential losses further along the manufacturing process.

Another known method of removing the wax from the shell mold is to use a flash-fire furnace. The furnace applies heat quickly to the wax/shell mold using gas burners focused on the mold. While this is a different method of applying heat to a cast, the outcomes in terms of likely damage to the shell mold are similar.

In order to try to alleviate these problems, the investment casting industry has sought to use various polymers to enhance the green strength of the ceramic coatings. Green Strength refers to the shell strength prior to elevated heating (>800° C.), in other words at temperatures <180° C. used for dewaxing. The green strength of the ceramic shell is of major importance as it reflects the strength of the shell during the dewax process. A higher green strength helps in overcoming shell cracking. Polymers used as green strength enhancers are useful only in assisting the processing of the shell mold up to the point it is pre-fired. They are removed by the pre-fire process (>800° C.), during which the strength of the shell mold is enhanced the formation of the required ceramic structures.

The current polymer enhanced binder systems available on the market mostly offer a relative green strength of 3-8 MPa after the molds have been built typically to a 3 to 6 mm thickness. The binder systems comprise polymers and other components such as wetting agents, anti-foams, and colloidal silica. The binder system is then, in turn, mixed with a ceramic flour to form an aqueous ceramic slurry suspension. Wax patterns are dipped into the slurry and a thin film of ceramic coating is applied to the surface of the wax. This thin layer is then stuccoed with a coarse sand particle and then air dried (commonly between 2-4 hours). The process is repeated until a desired thickness of ceramic shell is built around the wax surface.

The final coat in the process of the manufacture of the ceramic shell will commonly require what is known as a “seal coat”. The seal coat represents the final coat of slurry and is used primarily to prevent the prior layer of stucco from degrading and finding its way into the mold during the early handling of the mold. This detached stucco has the potential to becoming an unwanted inclusion and could lead to scrap or rework of the casting. Furthermore, the seal coat adds an additional layer of thickness which slightly enhances the mold green strength. The drawback of the seal coat is that it has the potential to reduce the permeability of the ceramic shell and can potentially cause gas defects and or cold shuts where the metal has failed to form.

In all these processes, there is a balance between the thickness of the ceramic shell required to seek to withstand the dewaxing and firing processes and the effectiveness of the final cast in the casting process. A thicker shell stands a greater chance of surviving dewaxing. However, this requires further manufacturing time, in applying additional layers of ceramic slurry and the associated drying, requires additional material and hence cost, and results in a heavier product. In addition, a thicker shell will potentially have a negative impact on the heat loss coefficient on the ceramic shell and may cause unwanted metallurgical defects during firing and also in the subsequent casting process. All this adds cost and processing time.

Examples of prior art shell forming methods are disclosed in U.S. Pat. No. 5,118,727 (Roberts), US 2006/0144556 A1 (Wang), U.S. Pat. No. 4,996,084 (Elkachouty), U.S. Pat. No. 5,824,730 (Guerra), U.S. Pat. No. 6,755,237 B2 (Duffey), U.S. Pat. No. 7,048,034 B2 (Vandermeer) and U.S. Pat. No. 7,588,633 B2 (Doles). All of these references disclose the use of a final seal coat with high levels of refractory material (typically in the range of 50-90% w/w).

### SUMMARY OF THE PRESENT INVENTION

The present invention seeks to provide an improved method and apparatus for producing a casting shell, an improved casting shell and to an improved method and apparatus for producing articles by means of the casting shell. The preferred embodiments are able to provide casting shells with improved strength and operational properties, particularly for use as investment casting molds.

According to an aspect of the present invention, there is provided a method of forming a ceramic casting shell comprising the steps of:

coating a wax former with one or more layers of a ceramic slurry;

drying the or each layer of ceramic slurry;

wherein the dried layer or layers of ceramic slurry form a ceramic shell;

applying over the ceramic shell, a coating of a polymer material;

heating the formed assembly to melt and remove the wax former, wherein the polymer coating acts as a strengthening layer to the ceramic shell during the wax removal process;

subsequent to removal of the wax former, heating the ceramic shell to melt and remove the polymer coating.

It has been found that the addition of a polymer coating overlying the ceramic shell significantly strengthens the ceramic shell for the dewaxing process. This results in reduced damage to ceramic shells during their manufacture. The polymer coating is a sacrificial layer which is subsequently removed. As a result, the final ceramic mold can be more precise, with no or fewer defects, and can be made thinner than prior art ceramic molds. A thinner mold uses less material, is faster to manufacture, and provides faster and hence cheaper casting.

Advantageously, the polymer coating is the outer coating of the ceramic shell.

The polymer coat is a distinct layer of the assembly, preferably having no or negligible ceramic material. It is not intended to form a material part of the final ceramic cast.

The polymer coating can be removed during firing of the ceramic shell, while in other embodiments can be removed prior to firing, for instance in a heating step at a temperature lower than firing temperature (typically 800 degrees Centigrade), for instance at 500 degrees Centigrade depending on the melting temperature of the polymer coating.

The polymer coating may be sprayed, dipped, painted onto the ceramic shell or applied in any other manner.

The polymer coating may be dried in air, or cured such as by UV curing. It is believed that UV curing can speed up the polymer drying process, and thereby the time required to manufacture the ceramic casts.

The polymer coating may be applied as a single layer of polymer material or could be applied in a plurality of layers or passes.

The polymer coating material used for the coating preferably has a viscosity with no shear at ambient temperature of 22° C. of at least 0.25 g/cm/s (25 centipoise), more preferably of at least 2.5 g/cm/s (250 centipoise) and most preferably of at least 5.0 g/cm/s (500 centipoise) or greater. A material of such viscosity, it has been found, forms an effective strengthening layer. A material of lower viscosity will generally not create a proper coating.

The wax is removed preferably at a temperature of up to around 180 degrees Centigrade.

In the preferred embodiments, the polymer coating comprises less than 35% w/w of refractory material. The refractory material could be comprised of silica or alumina from a binder or any other refractory ceramic material. Advantageously, the polymer coating is formed from a formulation including at least one polymer material, wherein the formulation includes less than 35% w/w of refractory material (preferably less than 20% w/w, more preferably less than 10% w/w, most preferably less than 5% w/w), with the balance being water. The formulation may be essentially free of refractory material.

The at least one polymer material preferably includes a polyvinyl alcohol, a styrene butadiene polymer, an acrylic polymer, an epoxy resin, a latex, or any combination thereof. The amount of the at least one polymer is preferably at least 5% w/w, preferably at least 12% w/w, more preferably at least 24% w/w, and most preferably at least 35% w/w.

The term “refractory material” is well known in the technical field. It means a material that is resistant to decomposition by heat, pressure, or chemical attack, and retains strength and form at high temperatures [e.g. Ailsa Allaby and Michael Allaby (1996). Concise Dictionary of Earth Sciences. Oxford Paperbacks Oxford University Press]. Common refractory materials which are used in the investment casting industry include silica, alumina, aluminium silicates, or zircon.

The polymer coating does not impact hot strength of the ceramic cast at all as it forms an outer coating that is sacrificed, avoiding unintentional strength gains in the ceramics hot state. It also avoids unnecessary voids that can be associated in prior art systems that seek to address the shell cracking problems by embedding additional amounts of polymer into the shell layers.

The formulation could be applied via dipping, spraying and or painting on to the underlying shell.

It is envisaged that in some embodiments the polymer coating is applied only to areas of the ceramic shell that are prone to localized dewax failures (for example on sharp edges or trailing edges on aerofoils). It is preferred, however, that the polymer coating is applied to the entire outer surface of the ceramic shell.

The ceramic shell mold will face a number of different operations as it is processed from manufacture through the investment process to the final removal after casting. The critical role of the shell mold is to form the molten metal into the desired shape and avoid any associated casting defects such as hot tearing or dimensional issues due to shell bulge. However, tuning the shell properties solely for the dewax stage of the process may not allow the shell to reach the casting stage fully intact.

In the current investment casting process, the shell does not reach the full strength until after the pre-cast mold firing stage. This dewax stage is already modified to reduce the stresses on the shell mold due to the expansion of the wax by applying heat quickly and using the poor thermal conductivity of the wax to prevent excessive bulk expansion of the wax pattern. As the thermal expansion coefficients of pattern and runner waxes are around an order of magnitude greater than the ceramic shell materials then this could result in significant stresses being applied to the shells.

In all cases of dewax, the expansion of the wax, whilst minimized, still applies a pressure to the shell. This pressure places the shell mold in tension, due to hoop stresses, as it resists this expansion. The outer polymer coating acts as a strengthening layer that reduces or minimizes the risk of shell cracking during the dewaxing process.

In some embodiments, the amount of refractory material in the polymer coating is less than 20% w/w, preferably less than 10% w/w.

The formulation for the polymer coating may include up to 5% w/w wetting and/or dispersing agent. The formulation may include up to 5% w/w antifoam, and/or up to 20% w/w organic material. The organic material may include cotton flock or natural fibres or organic fibres.

The step of heating the coated article in order to remove at least some of the polymer coating, preferably results an amount of solid residue left on the article of less than 35% w/w of the weight of the coating, preferably less than 20% w/w, most preferably less than 10% w/w.

According to another aspect of the present invention, there is provided a system for forming a ceramic casting shell comprising:

a ceramic shell forming station configured to coat a wax former with one or more layers of a ceramic slurry;

a drying station configured to dry the or each layer of ceramic slurry;

wherein the dried layer or layers of ceramic slurry form a ceramic shell;

a coating station configured to apply over the ceramic shell, a coating of a polymer material;

a heating station configured to heat the formed assembly to melt and remove the wax former, wherein the polymer coating acts as a strengthening layer to the ceramic shell during the wax removal process;

a heating station configured, subsequent to removal of the wax former, to heat the ceramic shell to melt and remove the polymer coating.

The system, or apparatus, may be formed to have physically separate stations, that is units or chambers designed to carry out the stated processing, or may comprise stations that are combined in a common unit or chamber. For instance, the ceramic shell forming station, the drying station and the coating station may be all comprised within the same unit of enclosure, with each station being formed by a specific apparatus component for the specific function. The same applies to the drying stations. Embodiments of apparatus are described below.

Advantageously, the coating station is configured to apply a polymer coating as the outer layer of the ceramic shell.

The polymer coat is a distinct layer of the assembly, preferably having no or negligible ceramic material, silica or alumina. It is not intended to form a material part of the final ceramic cast.

The polymer coating can be removed during firing of the ceramic shell, while in other embodiments can be removed prior to firing, for instance in a heating station configured to heat to a temperature lower than firing temperature (typically 800 degrees Centigrade), for instance at 500 degrees Centigrade depending on the melting temperature of the polymer coating. For this purpose, the heating station may be configured to heat to different temperatures, while in other embodiments the system may comprise first and second heating stations, the first being operable to heat to the lower, polymer coat melting temperature, and the second to heat to ceramic firing temperature.

Preferably, the coating station includes: a spray device, a dipping bath or a painting device for applying the polymer coating onto the ceramic shell.

The polymer coat drying station may be an air drier or a UV curing device. It is believed that UV curing can speed up the polymer drying process, and thereby the time required to manufacture the ceramic casts.

The coating station may be configured to apply a single layer of polymer material or multiple layers of polymer material.

The coating station is preferably configured to apply polymer material to the ceramic shell having a viscosity at ambient temperature of 22° C. of at least 0.25 g/cm/s (25 centipoise), more preferably of at least 2.5 g/cm/s (250 centipoise) and most preferably of at least 5.0 g/cm/s (500 centipoise), at room temperature. It is to be understood these viscosities are determined with no shear at ambient temperature.

The wax heating station is preferably configured to heat to a temperature of up to around 180 degrees Centigrade.

The polymer coating station is preferably configured to apply a polymer coating comprising less than 35% w/w of refractory material. Advantageously, the polymer coating station configured to apply a polymer coating comprising polymer coating is formed from a formulation including at least one polymer material, wherein the formulation includes less than 35% w/w of refractory material (preferably less than 20% w/w, more preferably less than 10% w/w, most preferably less than 5% w/w), with the balance being water. The formulation may be essentially free of refractory material.

The polymer coating station is preferably configured to apply a polymer coating at least one polymer material preferably including a polyvinyl alcohol, a styrene butadiene polymer, an acrylic polymer, an epoxy resin, a latex, or any combination thereof. The amount of the at least one polymer is preferably at least 5% w/w, preferably at least 12% w/w, more preferably at least 24% w/w, and most preferably at least 35% w/w.

The polymer coating station may be configured to apply polymer coating only to areas of the ceramic shell that are prone to localized dewax failures (for example on sharp edges or trailing edges on aerofoils). It is preferred, however, that the polymer coating station is configured to apply polymer coating to the entire outer surface of the ceramic shell.

According to another aspect of the present invention, there is provided a method of casting an article comprising the steps of:

filling a ceramic casting shell formed by the method taught herein with casting material;

providing for the casting material to harden;

removing the ceramic shell to reveal the cast article.

According to another aspect of the present invention, there is provided a cast article formed from a ceramic casting shell formed by the method taught herein.

Another aspect of the present invention is directed to the use of a ceramic casting shell formed by the method taught with casting material in the production of cast articles.

According to another aspect of the present invention, there is provided a method of improving the green strength of a ceramic article, including the steps of:

(a) coating a ceramic article with a formulation which includes at least one polymer,

(b) heating the coated article to a temperature from 0° C. to 1200° C., preferably from 100° C. to 1200° C., in order to remove at least 35% w/w of the weight of the coating, preferably less than 20% w/w, most preferably less than 10% w/w.

### BRIEF DESCRIPTION OF THE DRAWINGS

Embodiments of the present invention are described below, by way of example only, with reference to the accompanying drawings in which:

FIG. 1 shows a testing method that can be used to evaluate the strength of the examples;

FIG. 2 is a schematic flow chart of a preferred embodiment of method of forming a ceramic casting shell, and thereafter of forming a cast article;

FIG. 3 is a schematic diagram of an embodiment of system for forming a ceramic casting shell and for forming a cast article;

FIG. 4 is a photograph of three samples of a ceramic casting shell formed of four standard layers of ceramic slurry with an overlying ceramic seal coat according to the prior art;

FIG. 5 is a photograph of a side elevational view typical of the samples of FIG. 4, showing cracking of the shell after the dewaxing process;

FIG. 6 is an enlarged image of the side elevational view of FIG. 5;

FIG. 7 is a photograph of three samples of a ceramic casting shell formed of four standard layers of ceramic slurry with an overlying ceramic seal coat according to the prior art and provided with a wax escape hole;

FIG. 8 is a photograph of a side elevational view typical of the samples of FIG. 7, showing cracking of the shell after the dewaxing process;

FIG. 9 is an enlarged image of the side elevational view of FIG. 8;

FIG. 10 is a photograph of three samples of a ceramic casting shell formed of three standard layers of ceramic slurry with an overlying ceramic seal coat according to the prior art and provided with a wax escape hole;

FIG. 11 is a photograph of a side elevational view typical of the samples of FIG. 10, showing cracking of the shell after the dewaxing process;

FIG. 12 is an enlarged image of the side elevational view of FIG. 11;

FIG. 13 is a photograph of three samples of a ceramic casting shell formed of four standard layers of ceramic slurry with an overlying ceramic seal coat and an edge coat polymer sea according to an embodiment of the present invention and provided with a wax escape hole;

FIG. 14 is a photograph of a side elevational view typical of the samples of FIG. 13 after the dewaxing process;

FIG. 15 is an enlarged image of the side elevational view of FIG. 15;

FIG. 16 is a photograph of three samples of a ceramic casting shell formed of three standard layers of ceramic slurry with an overlying ceramic seal coat and an edge coat polymer seal according to an embodiment of the present invention and provided with a wax escape hole;

FIG. 17 is a photograph of a side elevational view typical of the samples of FIG. 16 after the dewaxing process;

FIG. 18 is an enlarged image of the side elevational view of FIG. 18;

FIG. 19 is a photograph of three samples of a ceramic casting shell formed of four standard layers of ceramic slurry with an overlying ceramic seal coat and a full coat polymer seal according to an embodiment of the present invention and provided with a wax escape hole;

FIG. 20 is a photograph of a side elevational view typical of the samples of FIG. 19 after the dewaxing process;

FIG. 21 is an enlarged image of the side elevational view of FIG. 20;

FIG. 22 is a photograph of three samples of a ceramic casting shell formed of three standard layers of ceramic slurry with an overlying ceramic seal coat and a full coat polymer seal according to an embodiment of the present invention and provided with a wax escape hole;

FIG. 23 is a photograph of a side elevational view typical of the samples of FIG. 22 after the dewaxing process; and

FIG. 24 is an enlarged image of the side elevational view of FIG. 23.

### TERMINOLOGY

Green Strength refers to the shell strength prior to elevated heating (>800° C.), in other words at temperatures <180° C. used for dewaxing.

Hot Strength: refers to the shell strength at elevated temperatures (>500° C.)

Post Fired strength: refers to the shell strength after pre-cast firing but at a temperature <100° C.

### First Example of Testing Method

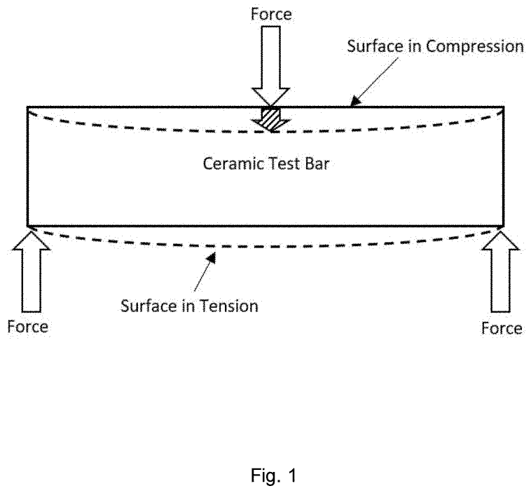

To evaluate the capability of the shell to cope with the dewax stage of the process, general shell evaluation has been carried out using a modulus-of-rupture (MoR) test (see FIG. 1). This test has a number of advantages in that it is straightforward to manufacture the test bars, it is easy to run the test and the results are easy to calculate.

A disadvantage of the test is that it does not perfectly replicate the conditions during dewax in terms of the loads placed on the shell by the wax expansion. The MoR test places one half of the shell thickness in tension, as the mold experiences at dewax, and the other half is in compression. As ceramics are always stronger in compression than tension then this effectively removes half the thickness from being evaluated during the test as it will never be the site of failure.

This has led to discussion within the investment casting community about the correct way to test MoR bars as the test either evaluates the capabilities of the face coat or the seal coat to withstand dewax. As the test will never replicate the real situation then it is not clear that this discussion will be resolved.

Also, the ceramic shell, when it cracks at dewax, predominantly fails from the edges of the wax. These edges act in two ways to enhance failure at dewax; firstly, they concentrate the stress in these areas making them more demanding in terms of the load; and secondly the shell build at edges is usually thinner than in plane sections so there is less material to carry the load.

In this invention the shell is preferably strengthened at its outer surface. If the MoR test is used in the most common application, whereby the face coat is placed in tension, then the test will not be designed to identify any advantage for the reinforcing coat. If the MoR test is conducted with the outer face in tension then the benefit of the reinforcement can be seen. This is due to the nature of the MoR tests as outlined above rather than any inherent issue with the reinforcement. During the dewax phase of the process the shell mold will be in tension throughout the thickness and as such the reinforcement will be of benefit.

The MoR test is, however, useful in the design of ceramic molds and in providing an early assessment of the benefits of the teachings herein.

### Practical Testing

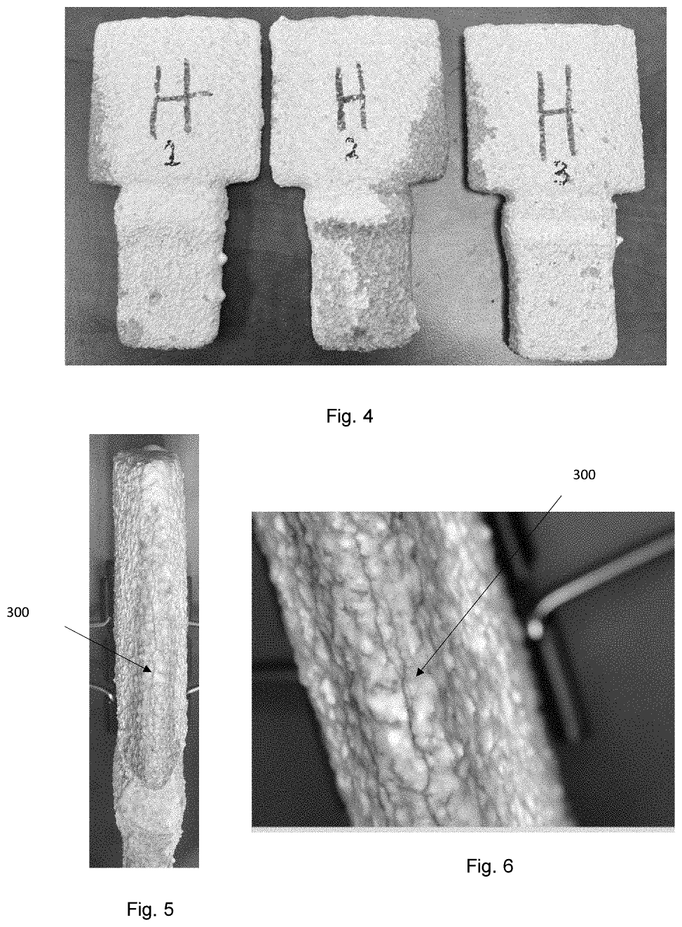

In addition to MoR testing, the applicant has carried out sample testing on a variety of shell structures. These are described below in connection with the photographs of FIGS. 4 to 24. The wax sample used was intentionally chosen to have sharp corners and narrow sections in order to seek to test the concepts disclosed herein to practical extremes.

### EXAMPLES

The shell molds used for evaluating the teachings herein were manufactured using a standard investment process with the shell molds being formed on wax patterns allowing modulus of rupture bars to be produced. The process steps are well defined in the literature. The shell molds were made in the following manner:

Prime coat: polymer enhanced silica binder system (Primcote Plus manufactured by Ransom & Randolph LLC or Remasol Adbond Advantage manufactured by Remet Corp, 80% loading of zirconium silicate flour, zirconium silicate stucco)

Intermediate coat: polymer enhanced silica binder system, 60% loading of silica flour, 50-100 mesh fused silica

Three back-up coats: polymer enhanced silica binder system, 60% loading of silica flour, aluminosilicate 47-22S

Seal coat: polymer enhanced silica binder system, 60% loading of silica flour

Some of the test bars were treated with the polymeric seal coat to evaluate the performance of this addition.

The drying times were four hours between coats and 24 hours final dry.

Following the production of the dried shell molds the edges are removed and the ceramic bars released from the wax.

MoR tests were undertaken at room temperature on an electric load frame with a cross-head speed of 25.4 mm/min. The dimensions of the bars were measured with digital callipers. Multiple results were taken for each formulation and the results averaged.

The polymeric seal coats were made up as described below and added to the test bars.

### Formulations:

1. Baseline shell system with standard seal coat without polymeric seal coat
2. Baseline shell system without standard seal coat without polymeric seal coat
3. 15% by weight poly vinyl alcohol solution seal coat, 85% water, without standard seal
4. Mixture comprising: 24.2 wt % water, 0.8 wt % wetting agent, 0.4 wt % bactericide, 40% styrene butadiene, 29% poly vinyl alcohol, 4% cotton flock, 1.6% antifoam, without standard seal
5. Mixture comprising: 34.97 wt % water, 0.55 wt % a wetting agent, 0.28 wt % bactericide, 27.75% acrylic styrene butadiene, 32.57% poly vinyl alcohol, 2.77% cotton flock, 1.11% antifoam, without standard seal
6. Mixture comprising: 34.97 wt % water, 0.55 wt % a wetting agent, 0.28 wt % bactericide, 27.75% acrylic styrene butadiene, 32.57% poly vinyl alcohol, 2.77% cotton flock, 1.11% antifoam, with standard seal

The results of the modulus of rupture testing are shown in Table 1.

TABLE 1

| | Average | | | |
|---|---|---|---|---|
| | Thickness | Average MoR | Average MoR | |
| Formulation | (mm) | (psi) | (MPa) | Improvement |
| 1 | 6.50 | 897 | 6.19 | — |
| 2 | 5.93 | 775 | 5.34 | — |
| 3 | 6.47 | 1719 | 11.86 | +121% |
| 4 | 6.59 | 1387 | 9.56 | +78% |
| 5 | 6.29 | 1422 | 9.81 | +83% |
| 6 | 6.42 | 1420 | 9.79 | +58% |

Formulation 2 has no ceramic seal coat and can be seen to be weaker than formulation 1 which has a ceramic seal coat. However, the addition of the polymeric seal coats (Formulations 3, 4 and 5) to the shell build without a ceramic seal coat can be seen to have improved MoR results of at least 78% above the baseline result (formulation 2).

When the ceramic seal is in place the results show less improvement but are still 58% better (formulations 1 and 6). The results in Table 1 are averages; however, if significance testing is undertaken on the full data sets then it can be shown that the improvements are classed as highly significant.

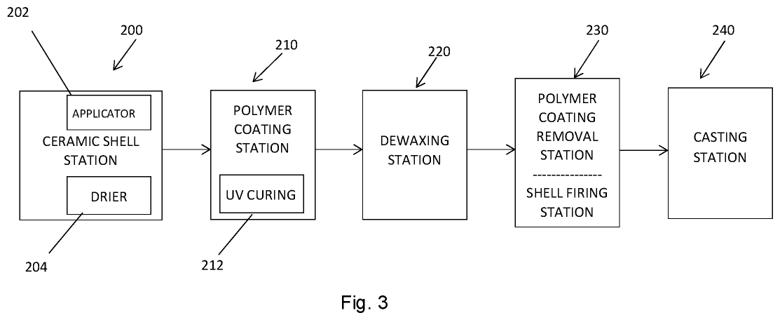

Referring now to FIG. 3, this is a flow chart, in schematic form, of the preferred method of forming a ceramic casting shell and, optionally, the process of using such a shell in the casting of articles, typically metal components.

The first part of the preferred method involves the preparation of the ceramic shell, which is typically formed by coating a wax former with a plurality of layers of a ceramic slurry. At step 100, a layer of ceramic slurry is coated over the wax former or over a previous ceramic layer, after which, at step 102, the newly applied ceramic slurry layer is dried. At step 104 it is determined whether the ceramic shell is of a sufficient thickness. This will typically be determined empirically and before the manufacture of the ceramic shell, using knowhow and principles well known in the art. If the ceramic shell is not yet of sufficient thickness, the process repeats step 100 and 102, until the shell is of sufficient thickness. Typically, a ceramic shell will comprise three of four layers, although these could be more in cases where the mold shape is such as to exhibit particularly large expansion forces during dewaxing and other process steps.

Once it is determined that the ceramic shell is of a sufficient thickness, the process passes to step 106, at which the process applies a polymer layer, as disclosed herein, preferably as the outermost surface of the ceramic shell. The polymer may be of any of the formulations and examples given herein. Optionally, prior to the application of the outer polymer layer, the ceramic shell may be coated with a conventional ceramic seal coat of a type known in the art, which would occur prior to step 106. The polymer layer may be applied in a variety of ways, for example by spraying, dipping or painting. It may be applied as a single layer or as multiple layers to form the final polymer coating. For this purpose, it is preferred that one layer of polymer coating is dried prior to application of any further layer. Drying maybe by air drying or any other suitable method. It is envisaged that UV drying could be particularly advantageous, as it can provide rapid curing of the polymer and as a consequence faster processing at this step.

The polymer coating material used for the coating preferably has a viscosity with no shear at ambient temperature of 22° C. of at least 0.25 g/cm/s (25 centipoise), more preferably of at least 2.5 g/cm/s (250 centipoise) and most preferably of at least 5.0 g/cm/s (500 centipoise) or greater. The higher the viscosity, the thicker the coat will be and the greater elasticity it will have.

At step 108 the process removes the was former from within the shell, by a conventional dewaxing process. This is typically carried out at a temperature up to 180° C., which causes the wax to melt and leak out of the surrounding shell. For this purpose, the ceramic shell is typically provided with one or more apertures to allow the wax to flow out of the shell. The dewaxing step 108 may be carried out by any of the methods described above, including by rapid heating of the ceramic shell. As described herein, as a consequence of the provision of the polymer coating, it has been found that the shell structure is much stronger than prior art structures and that there is significantly reduced incident of cracking of the ceramic shell during the dewaxing stage 108. Examples are provided below.

At step 110 the process removes the polymer outer coating. This is typically removed by heating the ceramic shell to a temperature of around 500° C., although this is dependent upon the melting temperature of the particular polymer used for the outer coating. After step 110, the surrounding shell is formed solely of ceramic layers. In the preferred embodiments, the ceramic layers may have no polymer constituents in them or only modest amounts of polymer, thereby reducing the existence of any voids within the ceramic shell of the type known in the prior art.

At step 112, the ceramic shell is fired, typically at a temperature of around 800° C., as disclosed herein.

It is to be understood that steps 110 and 112 could in effect be combined in a two-stage filing process, in which at a first stage of the heating the polymer outer coating is removed, by heating the shell to a lower temperature, and in a second stage, upon increasing heating temperature, the remaining ceramic shell is fired.

Once completed, the fired ceramic shell can be used for casting, at step 114, typically metal components. The casting can be by any of the well known methods.

It will be appreciated from the teachings herein that the cast components made by this process are likely to be more precisely manufactured as a result of the avoidance or significant reduction in defects caused during the dewaxing of the ceramic shell. Additionally, as demonstrated below, the process enables the manufacture of ceramic shells that are thinner than prior art shells and yet can still withstand the dewaxing process, and to do so much more effectively than other ceramic shell manufacturing methods. As a consequence of the use of a thinner shell, heat can be transferred faster into the casting. This can significantly speed up the casting process as well as making it more precise. As explained above, the ability to provide thinner shells also reduces the amount of material required for the manufacture of the shells and the time for manufacture, resulting in manufacturing savings and the shell making stage.

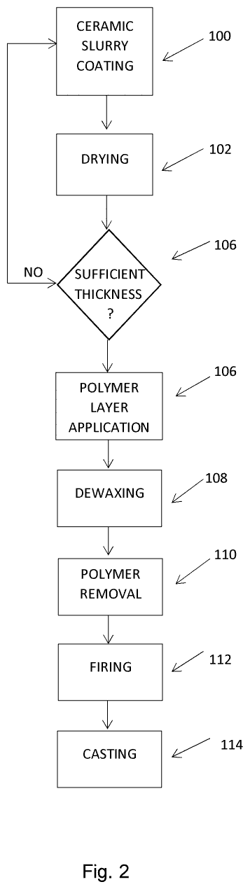

Referring now to FIG. 3, this shows in schematic form an embodiment of system (apparatus) for carrying out the method taught herein of which an example is shown in FIG. 2. The apparatus comprises a ceramic shell station 200 which includes an applicator 202 and a dryer 204. The ceramic shell station 200 is configured to form the ceramic shell, typically by the application of a plurality of layers of ceramic slurry to a wax former. The applicator used for this may be a bath of ceramic slurry, a spraying device or a painting device, for example. The station 200 also includes a dryer of known form, configured to dry each layer of ceramic slurry applied to the former.

The apparatus also includes a polymer coating station 210 for applying a polymer outer coating to the formed ceramic shell, as previously described. The polymer coating station 210 may include a UV curing device 212, or other drying device, to dry the polymer coating. Instead of a UV curing device, an air drier or other suitable polymer coating drying device may be used. It is to be understood that the polymer coating station 210 may in some embodiments be a part of the ceramic shell station and in the form of a polymer applicator within the station 200.

In other embodiments, the polymer coating station may be a separate stage in the apparatus. In accordance with the disclosure herein, the polymer coating could be applied in a single layer or in multiple layers. The coating station 210 may be configured for either or both of these possibilities, such configurations being well within the ability of the skilled person.

The apparatus also includes a dewaxing station 220, of known form and as described herein. The dewaxing station 220 is configured to heat the formed ceramic shell (with the polymer outer coating) in order to remove the wax former. Dewaxing is typically carried out at temperatures up to 180° C.

The apparatus also includes a polymer coating removal station and a shell firing station 230. These may be separate units of the apparatus or, as previously described, could be a singular unit configured to operate first to remove polymer and then to fire the shell. The polymer coating removal station 230 is configured to heat the polymer coated ceramic shell to slightly above the melting temperature of the polymer, typically around 500° C., although this is dependent upon the nature of the polymer coating. The shell firing station is configured to fire the ceramic shell (after removal of the outer polymer coating) to a typical firing temperature of around 800° C. or more.

The apparatus may also include a casting station 240 for casting products using the ceramic shell formed at stations 200-230. It is to be understood that the casting station 240 may not be physically connected to the other parts of the apparatus. It may be a separate station, for example at the third party site.

FIGS. 4 to 24 are photographs showing sample ceramic shells manufactured according to prior art methods and manufactured according to the methods taught herein.

With reference to FIG. 4 first, this shows a set of ceramic shells formed over a wax former which could be described as having a flat hammer shape. The ceramic shells shown in FIG. 4 will typically have an aperture (at the bottom of the samples shown in FIG. 4) for release of molten wax during the dewaxing process.

The shells shown in FIG. 4 have a conventional structure with four standard coats of ceramic slurry and a standard ceramic outer seal coat, as described above.

FIGS. 5 and 6 show an example of the samples of FIG. 4 after the dewaxing process. As can be seen in these photographs, the ceramic shell has cracked at its edges. Crack lines 300 are indicated by the arrows in these figures.

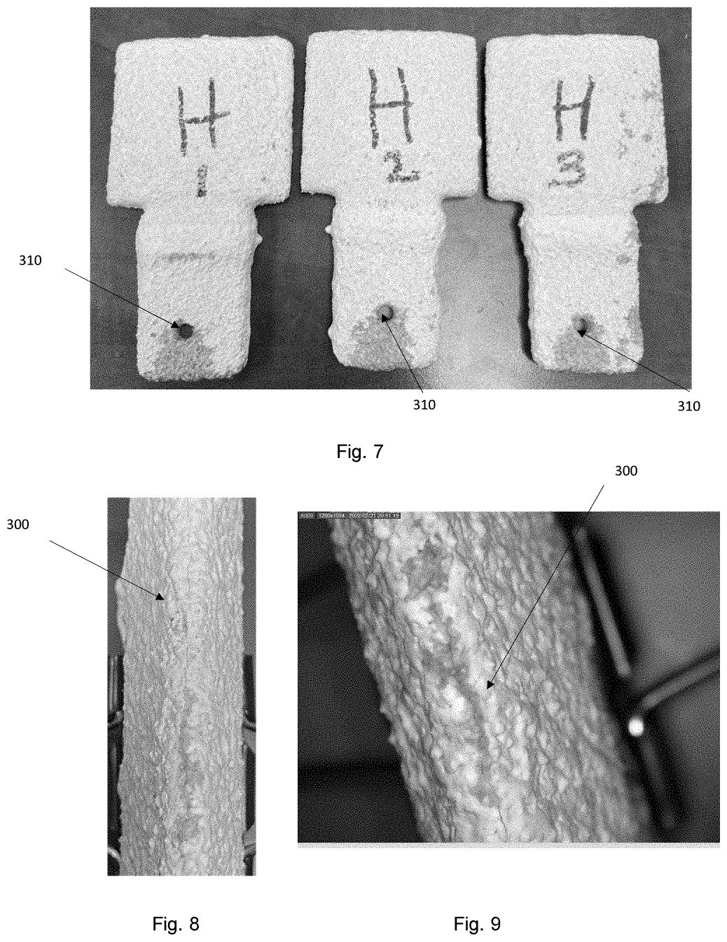

With reference now to FIG. 7 this shows another example of ceramic shell similar to the example of FIG. 4 and formed in the same way. That is, the shell comprises four layers of ceramic material and a conventional outer ceramic seal coat. The difference lies in the provision of additional wax escape holes 310. These are often advantageous with complex or delicate shell formations which may be prone to particularly large dewaxing pressures as can occur for example with the shapes shown in the Figures. Despite the presence of the wax escape holes 310 in the ceramic shells, shells of FIG. 7 can still suffer from significant cracking, as can be seen in the example shell of FIG. 7 shown in FIGS. 8 and 9.

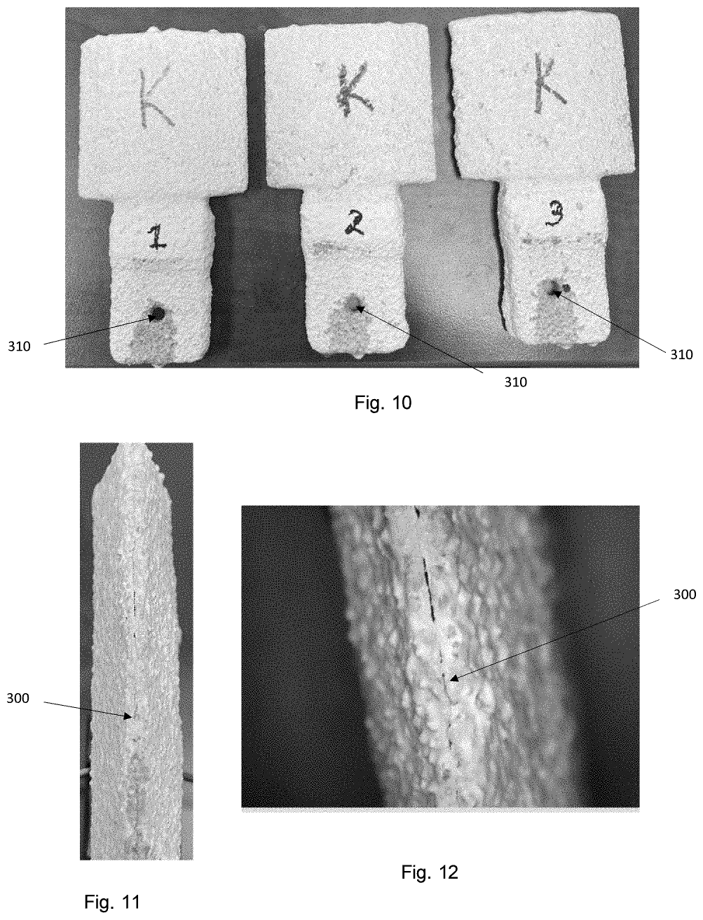

FIG. 10 shows another example according to the prior art, in which the shells are formed with three standard layers of ceramic (that is three coatings of ceramic slurry) and a standard ceramic seal coat. These samples also include wax escape holes 310. As can be seen in FIGS. 11 and 12, these ceramic shells formed by the prior art method are also prone to cracking during the dewaxing process.

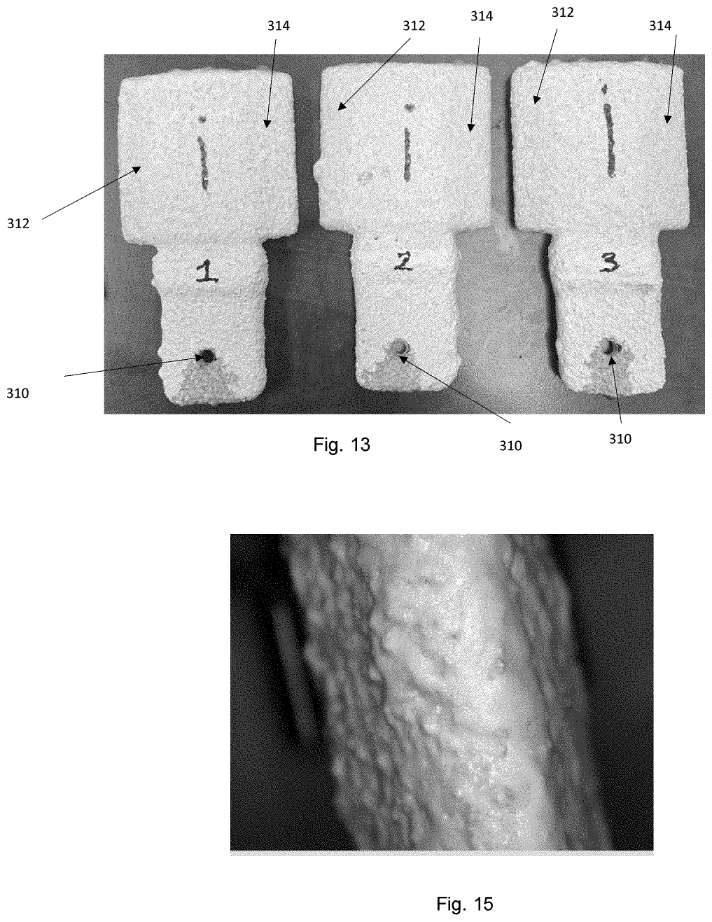

Referring now to FIGS. 13-15, these shows a first embodiment of ceramic casting shells made according to the present invention. This embodiment also includes, as previously described, wax escape holes 310. These are additional holes 310 not necessary but are advantageous in cases where the shape of the shell can be subject to particularly high dewaxing stresses. The embodiment of FIG. 13 includes ceramic shells comprising four standard coats of ceramic material and a standard ceramic seal coat. Disposed to overlie the sides of the ceramic shell, typically the sides 312, 314, is a polymer coating, as described herein. The polymer coating is preferably applied over every sharp edge of the ceramic shell. With reference to FIGS. 14 and 15, these show an example of the shell of FIG. 13 after the dewaxing process. As can be seen in these Figures, there has been no cracking of the shell as a result of the dewaxing process.

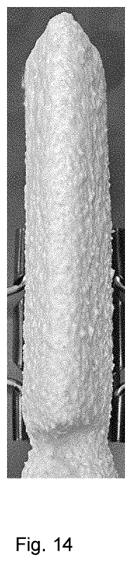

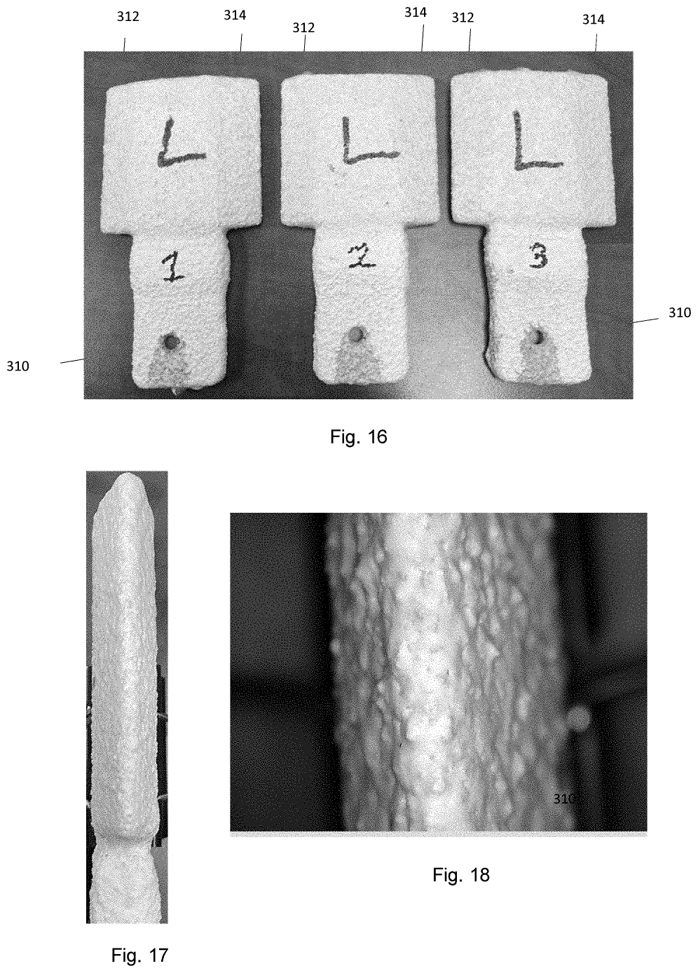

FIG. 16 shows samples similar to those of FIG. 13, although in this example being formed of a thinner ceramic shell, typically of three layers of ceramic material (that is three coatings of ceramic slurry) and a ceramic seal coat. An outer polymer coating is provided, again at the edges of the ceramic shell as indicated by reference numerals 312 and 314. With reference to FIGS. 17 and 18, these show one of the samples of FIG. 16 after the dewaxing process, where it can be seen that there has been no cracking of the shell.

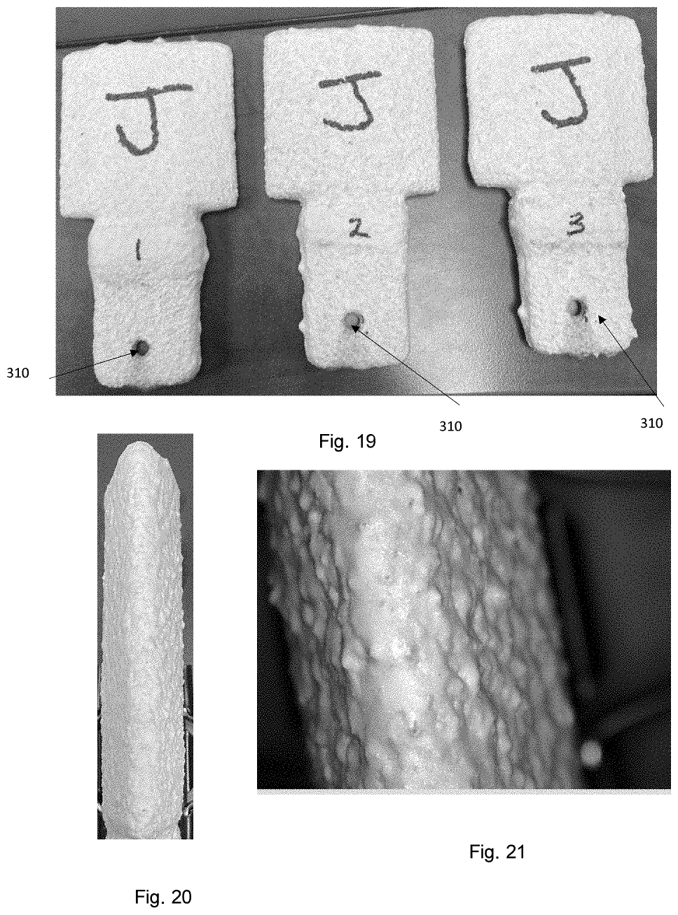

FIG. 19 shows another embodiment in which the shell is formed of four standard coats of ceramic material and a conventional ceramic seal coat overlying the four ceramic coats. It is to be understood that the four coats of ceramic material are four layers of ceramic slurry applied to a wax former. In the embodiment of FIG. 19, the entirety of the outer surface of the ceramic shell is coated with an outer polymer coating of the type described herein. With reference to FIGS. 20 and 21, these show one of the samples of FIG. 19 after the dewaxing process. As can be seen from these photographs, there is no cracking of the shell.

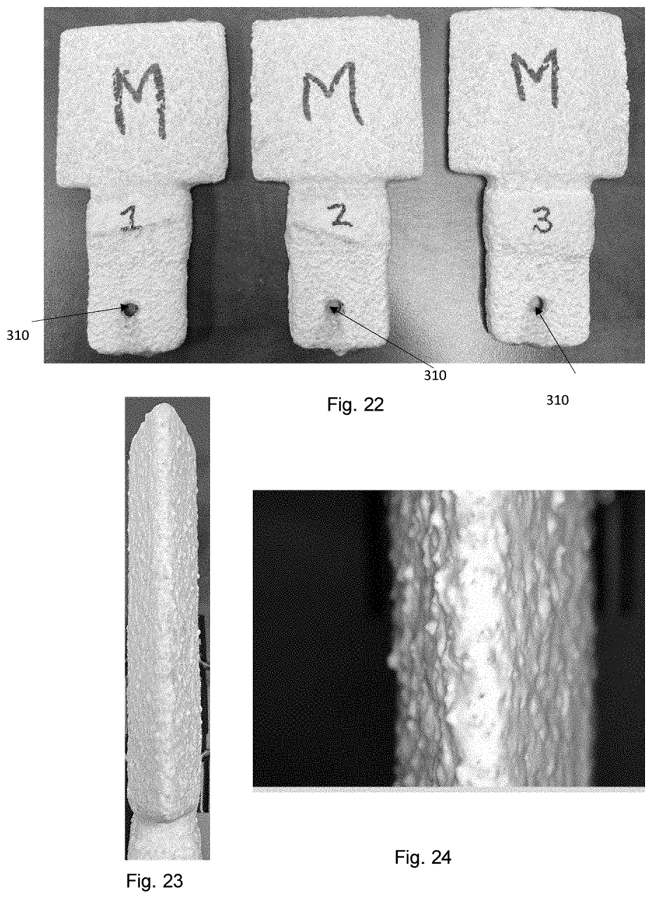

The embodiment of FIG. 22 is similar to that of FIG. 19 and comprises a ceramic shell formed from three layers of ceramic slurry and a ceramic seal coat with a full coating of polymer material overlying the ceramic casting shell. Again, the samples of this embodiment have been provided with wax escape holes 310, which as explained need only be used in cases where the design of the mold is the subject particularly high dewaxing expansion pressures. With reference to FIGS. 23 and 24 these show one of the samples of FIG. 22 after the dewaxing process, where it can be seen that there has been no cracking of the ceramic shell.

The examples described above and shown in FIGS. 13 to 24 it can be that the provision of an outer polymer coating can significantly strengthen the ceramic shell particularly during the dewaxing process and as a consequence significantly reduce the chances of cracking of the ceramic shell during the dewaxing process. Furthermore, this enables the manufacture of ceramic shells with much thinner walls, which reduces the amount of material required for casting, the time required to make the ceramic casting shells and can also lead to reduction in casting times through the use of thinner shells. These are all considered significant advantages over the art. By contrast, the shells formed by the prior art method can only be strengthened by increasing the thickness of the shell, that is by applying further coats of ceramic slurry, which can lead to undue thickening of the shells. In the alternative and also additionally, the prior art shells may need fixing after dewaxing in order to plug any cracks formed.

It is to be understood that although the above described embodiments of ceramic casting shells comprised an outer ceramic seal coat, such a seal coat is not necessary and other embodiments could be formed of layers of dried ceramic slurry and an outer polymer layer.

In accordance with the teachings herein, exemplary versions of the invention include the following features:

Feature 1. A method of forming a ceramic casting shell comprising the steps of:

coating a wax former with one or more layers of a ceramic slurry;

drying the or each layer of ceramic slurry;

wherein the dried layer or layers of ceramic slurry form a ceramic shell;

applying over the ceramic shell, a coating of a polymer material;

heating the formed assembly to melt and remove the wax former, wherein the polymer coating acts as a strengthening layer to the ceramic shell during the wax removal process;

subsequent to removal of the wax former, heating the ceramic shell to melt and remove the polymer coating.

Feature 2. A method according to feature 1, wherein the polymer coating is the outer coating of the ceramic shell.

Feature 3. A method according to feature 1 or 2, wherein the polymer coating is a distinct layer of the assembly having no or negligible ceramic material.

Feature 4. A method according to any preceding feature, wherein the polymer coating is removed during firing of the ceramic shell.

Feature 5. A method according to any one of features 1 to 3, wherein the polymer coating is removed prior to firing.

Feature 6. A method according to any preceding feature, wherein the polymer coating is applied by spraying, dipping or painting onto the ceramic shell.

Feature 7. A method according to any preceding feature, wherein the polymer coating is dried in air or cured by UV curing.

Feature 8. A method according to any preceding feature, wherein the polymer coating is applied as a single layer of polymer material.

Feature 9. A method according to any preceding feature, wherein the polymer coating is applied in a plurality of layers or passes.

Feature 10. A method according to any preceding feature, wherein the polymer material used for the coating has a viscosity at ambient temperature of at least 0.2 g/cm/s (20 centipoise) with no shear.

Feature 11. A method according to any preceding feature, wherein the polymer material used for the coating has a viscosity at ambient temperature with no shear of at least 0.25 g/cm/s (25 centipoise), preferably of at least 2.50 g/cm/s (250 centipoise), more preferably of at least 5.0 g/cm/s (500 centipoise).

Feature 12. A method according to any preceding feature, wherein the polymer coating comprises less than 35% w/w of refractory material.

Feature 13. A method according to any preceding feature, wherein the polymer coating is formed from a formulation including at least one polymer material, wherein the formulation includes less than 35% w/w of refractory material (preferably less than 20% w/w, more preferably less than 10% w/w, most preferably less than 5% w/w), with the balance being water.

Feature 14. A method according to any preceding feature, wherein the polymer coating is essentially free of refractory material.

Feature 15. A method according to any preceding feature, wherein the polymer material used for the coating includes a polyvinyl alcohol, a styrene butadiene polymer, an acrylic polymer, an epoxy resin, a latex, or any combination thereof.

Feature 16. A method according to feature 15, wherein the amount of the at least one polymer is at least 5% w/w, preferably at least 12% w/w, more preferably at least 24% w/w, and most preferably at least 35% w/w.

Feature 17. A method according to any preceding feature, wherein the polymer coating is applied to a part of the ceramic shell.

Feature 18. A method according to any one of features 1 to 16, wherein the polymer coating is applied to the whole of the ceramic shell.

Feature 19. A system for forming a ceramic casting shell comprising:

a ceramic shell forming station configured to coat a wax former with one or more layers of a ceramic slurry;

a drying station configured to dry the or each layer of ceramic slurry;

wherein the dried layer or layers of ceramic slurry form a ceramic shell;

a coating station configured to apply over the ceramic shell, a coating of a polymer material;

a heating station configured to heat the formed assembly to melt and remove the wax former, wherein the polymer coating acts as a strengthening layer to the ceramic shell during the wax removal process;

a heating station configured, subsequent to removal of the wax former, to heat the ceramic shell to melt and remove the polymer coating.

Feature 20. A system according to feature 19, wherein the system is formed to have physically separate stations.

Feature 21. A system according to feature 19 or 20, wherein the system comprises stations combined in a common unit or chamber.

Feature 22. A system according to any one of features 19 to 21, wherein the coating station is configured to apply a polymer coating as the outer layer of the ceramic shell.

Feature 23. A system according to any one of features 19 to 22, wherein the polymer coat is a distinct layer of the assembly

Feature 24. A system according to any one of features 19 to 23, wherein the heating station is configured to heat to a temperature lower than firing temperature so as to remove the polymer coating.

Feature 25. A system according to any one of features 19 to 24, wherein the coating station includes: a spray device, a dipping bath or a painting device for applying the polymer coating onto the ceramic shell.

Feature 26. A system according to any one of features 19 to 25, wherein the polymer coating drying station is an air drier or a UV curing device.

Feature 27. A system according to any one of features 19 to 26, wherein the coating station is configured to apply a single layer of polymer material or multiple layers of polymer material.

Feature 28. A system according to any one of features 19 to 27, wherein the coating station is configured to apply polymer material to the ceramic shell having a viscosity at ambient temperature with no shear of at least 0.2 g/cm/s (20 centipoise), more preferably of at least 0.25 g/cm/s (25 centipoise), preferably of at least 2.50 g/cm/s (250 centipoise), more preferably of at least 5.0 g/cm/s (500 centipoise).

Feature 29. A system according to any one of features 19 to 28, wherein the wax heating station is configured to heat to a temperature of up to around 180 degrees Centigrade.

Feature 30. A system according to any one of features 19 to 29, wherein the polymer coating station comprises a source of material for the polymer coating comprising less than 35% w/w of refractory material.

Feature 31. A system according to any one of features 19 to 30, wherein the polymer coating station comprises a source of material for the polymer coating comprising a formulation including at least one polymer material, wherein the formulation includes less than 35% w/w of refractory material (preferably less than 20% w/w, more preferably less than 10% w/w, most preferably less than 5% w/w), with the balance being water.

Feature 32. A system according to any one of features 19 to 31, wherein the polymer coating station comprises a source of material for the polymer coating including a polyvinyl alcohol, a styrene butadiene polymer, an acrylic polymer, an epoxy resin, a latex, or any combination thereof.

Feature 33. A system according to any one of features 19 to 32, wherein the polymer coating station is configured to apply polymer coating to a part of a ceramic shell or to the whole of a ceramic shell.

Feature 34. A method of casting an article comprising the steps of: filling a ceramic casting shell formed by a method according to any one of claims 1 to 18 with casting material;

providing for the casting material to harden;

removing the ceramic shell to reveal the cast article.

Feature 35. A cast article formed from a ceramic casting shell formed by a method according to any one of features 1 to 18.

Feature 36. Use of a ceramic casting shell formed by a method according to any one of clauses 1 to 18 in the production of cast articles.

The disclosures in British patent application number GB21074133.1, from which this application claims priority, and in the abstract accompanying this application are incorporated herein by reference.

1. A method of forming a ceramic casting shell comprising the steps of:
coating a wax former with one or more layers of a ceramic slurry;
drying each layer of ceramic slurry, thereby forming a ceramic shell;
applying a coating of a polymer material over the ceramic shell;
heating the ceramic shell to melt and remove the wax former, wherein the polymer coating strengthens the ceramic shell during the wax removal process;
following removal of the wax former, heating the ceramic shell to melt and remove the polymer coating.

2. The method of claim 1 wherein the polymer coating defines the outer coating of the ceramic shell.

3. The method of claim 1 wherein the polymer coating is a distinct layer having no or negligible ceramic material therein.

4. The method of claim 1 further including the step of firing the ceramic shell, wherein the polymer coating is removed during or prior to firing of the ceramic shell.

5. The method of claim 1 wherein the polymer coating is applied by one of:
spraying, dipping and painting onto the ceramic shell.

6. The method of claim 1 wherein the polymer coating is dried in air or cured by UV curing.

7. The method of claim 1 wherein the polymer material used for the coating has a viscosity at ambient temperature with no shear of one of:
at least 0.25 g/cm/s (25 centipoise),
at least 2.50 g/cm/s (250 centipoise), and
at least 5.0 g/cm/s (500 centipoise).

8. The method of claim 1 wherein the polymer material has one of:
less than 35% w/w of refractory material;
less than 20% w/w of refractory material;
less than 10% w/w;
less than 5% w/w;
with the balance being water.

9. The method of claim 1 wherein the polymer material includes a polyvinyl alcohol, a styrene butadiene polymer, an acrylic polymer, an epoxy resin, a latex, or any combination thereof.

10. The method of claim 1 wherein the polymer coating is applied to only a portion of the ceramic shell.

11. The method of claim 1 further including the step, following removal of the polymer coating, of producing a cast article by use of the ceramic shell.

12. The method of claim 1 further including the steps of:
following removal of the polymer coating, filling the ceramic shell with casting material;
following hardening of the casting material, removing the ceramic shell to reveal a cast article.

13. A cast article formed by the method of claim 12.

14. A system for forming a ceramic casting shell comprising:
a ceramic shell forming station configured to coat a wax former with one or more layers of a ceramic slurry;
a drying station configured to dry each layer of ceramic slurry, thereby forming a ceramic shell;
a coating station configured to apply a polymer coating over the ceramic shell;
a first heating station configured to heat the coated ceramic shell to melt and remove the wax former, wherein the polymer coating defines a strengthening layer for the ceramic shell during the wax removal process;
a second heating station configured to heat the ceramic shell after removal of the wax former to melt and remove the polymer coating.

15. The system of claim 14 wherein the stations are physically separate.

16. The system of claim 14 wherein at least two of the stations are combined in a common unit or chamber.

17. The system of claim 14 wherein the coating station is configured to apply the polymer coating to define an outer layer on the ceramic shell.

18. The system of claim 14 wherein the heating station is configured to heat to a temperature lower than firing temperature to thereby remove the polymer coating.

19. The system of claim 14 wherein the coating station includes one of: a spray device, a dipping bath and a painting device for applying the polymer coating over the ceramic shell.

20. The system of claim 14 further including a polymer coating drying station including an air drier or a UV curing device.

21. The system of claim 14 wherein the polymer coating station comprises a polymer coating source containing at least one polymer material having one of:
less than 35% w/w of refractory material,
less than 20% w/w of refractory material,
less than 10% w/w of refractory material, and
less than 5% w/w) of refractory material,
with the balance being water; and
the polymer material including one of: a polyvinyl alcohol, a styrene butadiene polymer, an acrylic polymer, an epoxy resin, a latex, or any combination thereof.
